(19) United States
(12) Patent Application Publication
(10) Pub. No.: US 2015/0310402 A1
(43) Pub. Date: Oct. 29, 2015

(54) TRANSACTION CONVERSION WITH PAYMENT CARD

(71) Applicant: EBAY INC., San Jose, CA (US)

(72) Inventor: Vijayakumar Balusamy, San Jose, CA (US)

(21) Appl. No.: 14/262,624

(22) Filed: Apr. 25, 2014

(51) Int. Cl. G06Q 20/10; G06Q 20/34; G06Q 20/22

(52) U.S. Cl. CPC G06Q 20/10; G06Q 20/227; G06Q 20/34

(57) ABSTRACT

Methods and systems for facilitating payment are described. A user presents a payment card (e.g., credit or bank card) during checkout, and payment card details are transmitted to a service provider. The service provider receives the details and determines that the payment card is linked to an account with the service provider. The service provider identifies the user account linked to the payment card and processes the transaction using the funding sources available in the user account. The funding sources used may include the payment card or may be different.

### BACKGROUND

1. Field of the Invention

The present invention generally relates to electronic commerce, and more particularly to using a payment card to access a service provider account and using the service provider account to fund a transaction.

2. Related Art

Typically, a buyer presents a merchant with a payment card, such as a credit or debit card, during the purchase of goods or services. The credit or debit card is swiped or scanned by a card reader. The card reader reads the identity of the buyer associated with the card and the account from which the buyer wishes to pay for the purchase.

Buyers, however, may wish to make purchases with funds drawn from different payment sources. To do this, the buyer must usually carry each card for each different payment source, or have them on hand when making an electronic purchase. In addition, many times the card that the buyer brings is not the one accepted by the merchant. This is inconvenient and a hassle for the buyer.

Thus, a need exists for systems and methods that allow a buyer to access a different payment source than the payment card.

### BRIEF DESCRIPTION OF THE FIGURES

FIG. 1 is a block diagram illustrating a system for facilitating payment according to an embodiment of the present disclosure;

FIG. 2 is a flowchart showing a method for facilitating payment according to an embodiment of the present disclosure; and

FIG. 3 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that facilitate payment. When a user present a payment card (e.g., bank or credit card company issued credit card or debit card) at checkout, the card reader or other merchant device transmits payment card information to a service provider. The card reader does not call the issuer of the payment card (e.g., bank, credit card company, or other financial institution). Instead, the card reader or other merchant device contacts the service provider and provides the service provider with payment card details. The service provider receives the details and determines that the payment card is linked to a user account with the service provider. The service provider identifies the user account and processes the transaction using the funding sources available in the user account. The funding source(s) used may be the same as the payment card or may be different.

The payment card, in various embodiments, is selected to be a unique card tied to a single user. In one embodiment, the payment card identifies the user and acts as the user's login credentials (e.g., user name and password) to access the user's account. Instead of entering a user name, password, and/or personal identification number (PIN), the user merely swipes the payment card at the register or enters the payment card details online.

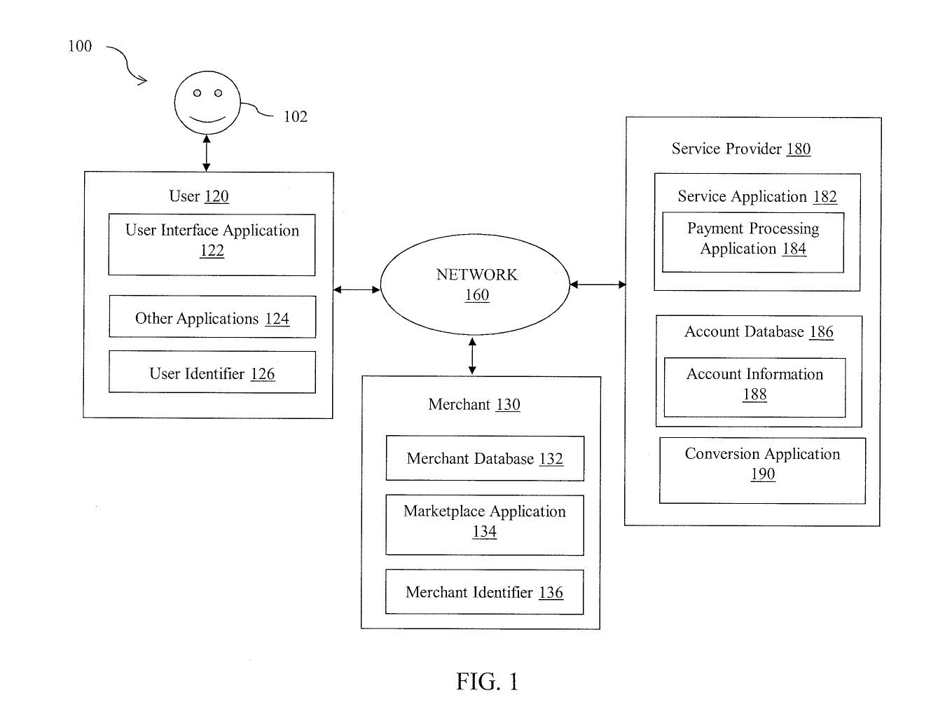

FIG. 1 shows one embodiment of a block diagram of a network-based system 100 adapted to facilitate payment with a user device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 (e.g., a smartphone), one or more merchant servers or devices 130 (e.g., network server devices), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 120, in one embodiment, may be utilized by the user 102 to interact with the merchant device 130 and/or the service provider server 180 over the network 160. For example, the user 102 may conduct financial transactions (e.g., account transfers) with the service provider server 180 via the user device 120. The user device 120, in various embodiments, may be implemented using any appropriate combination of hardware and/or software configured for wired and/or wireless communication over the network 160. In various implementations, the user device 120 includes a wireless telephone (e.g., cellular or mobile phone), a tablet, a personal computer, a notebook computer, a wearable computing device, and/or various other generally known types of wired and/or wireless computing devices.

The user device 120, in one embodiment, includes a user interface application 122, which may be utilized by the user 102 to conduct transactions (e.g., shopping, purchasing, bidding, etc.) with the merchant device 130 and/or service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The user device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the user 102 based on activity from the user device 120 (e.g., cell phone). The user profile may be updated with each financial and/or information transaction (e.g., payment transaction, purchase transaction, etc.) achieved through use of the user device 120. In various aspects, this may include the type of transaction and/or the location information from the user device 120. As such, the profile may be used for recognizing patterns of potential fraud, setting transaction limits on the user, etc.

The user device 120, in one embodiment, may include at least one user identifier 126, which may be implemented, for example, as operating system registry entries, cookies associated with the user interface application 122, identifiers associated with hardware of the user device 120, or various other appropriate identifiers. The user identifier 126 may include one or more attributes related to the user 102, such as personal information related to the user 102 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering items to the user 102 over the network 160. As such, each of the one or more merchant servers 130 may include a merchant database 132 for identifying available items, which may be made available to the user device 120 for viewing and purchase by the user 102. In one or more embodiments, user 102 may complete a transaction such as purchasing the items via service provider server 180.

Each of the merchant servers 130, in one embodiment, may include a marketplace application 134, which may be configured to provide information over the network 160 to the user interface application 122 of the user device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. The merchant identifier 136 may include attributes related to the merchant server or device 130, such as identification information (e.g., a serial number, a location address, GPS coordinates, a network identification number, etc.). In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to a merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of the service provider as a payment intermediary. The merchant website may also have an account with the service provider.

The service provider server 180, in one embodiment, may be maintained by a transaction processing entity or an online service provider, which may provide processing for financial transactions and/or information transactions between the user 102 and one or more of the merchant servers 130. As such, the service provider server 180 includes a service application 182, which may be adapted to interact with the user device 120 over the network 160 to facilitate the searching, selection, purchase, and/or payment of items by the user 102 from the one or more merchant servers 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and each of the merchant servers 130. In one implementation, the payment processing application 184 assists with resolving financial transactions through validation, delivery, and settlement. As such, the service application 182 in conjunction with the payment processing module 184 settles indebtedness between the user 102 and each of the merchant servers 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 186, each of which may include account information 188 associated with one or more individual users (e.g., user 102) and merchants. For example, account information 188 may include private financial information of user 102 and merchants (e.g., one or more merchants associated with merchant servers 130), such as one or more account numbers, passwords, credit card information, banking information, or other types of financial information, which may be used to facilitate financial transactions between user 102, and one or more merchants associated with the merchant servers 130. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 includes a conversion application 190. The conversion application 190 receives payment card details (e.g., account number), locates a user account based on the received details, and retrieves a funding source linked to the user account. In one embodiment, the funding source is the same as the payment card, while in another embodiment, the funding source is different.

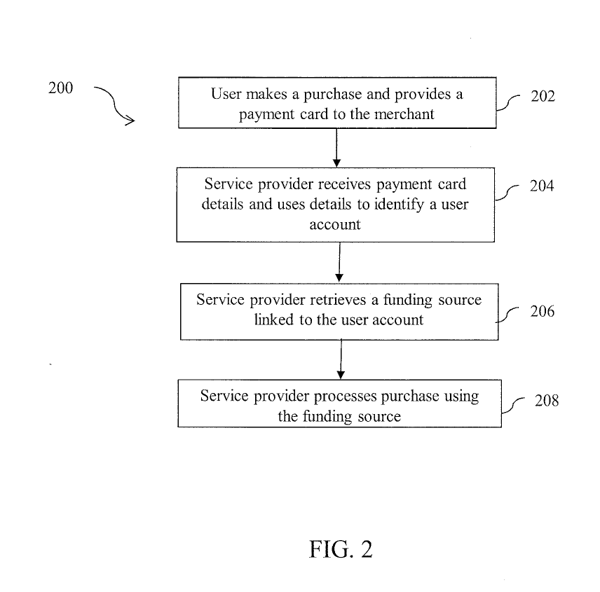

Referring now to FIG. 2, a flowchart 200 of a method for facilitating payment is illustrated according to an embodiment of the present disclosure. In various embodiments, the user 102 registers with a service provider. Registration may include signing up for the service and agreeing to any terms required by the service provider, such as through user device 120. In one embodiment, the user device 120 is a mobile computing device, such as a smart phone, a PC, or a computing tablet. In other embodiments, registration may be done completely through the user device 120, partially through the user device 120, or without using the user device 120, such as through a phone call or in-person visit to a representative of the service provider.

The user 102 may be requested to provider specific information for registration, such as, but not limited to, a name, address, phone number, email address, picture, a user name for the account, and a password or PIN for the account. The type of information requested may depend on whether the user 102 already has an account with the service provider. Requested information may be entered through the user device 120 or other means, including voice or manual key entry. Once all the requested information is received and confirmed, the service provider may create an account for the user.

In some embodiments, the user 102 is requested to enter funding sources for the user account. Funding sources include, for example, a credit card or debit card (e.g., Visa®, MasterCard®, Capital One®, Discover® or American Express® card, or), a bank account (e.g., Wells Fargo or Bank of America® checking account), a gift card (e.g., Wal-Mart gift card), prepaid card, line-of-credit, check, money order, etc. The user 102 has the option of adding further funding sources, or to edit or delete existing funding sources. In some embodiments, the user 102 selects a primary or default funding source.

In an exemplary embodiment, the user 102 selects a payment card (e.g., credit or debit card) to be used as a login identity to his or her user account with the service provider. The payment card acts as unique identification tied to the user 102. The payment card is not issued or managed by the service provider. In some cases, the payment card is associated with a store or retailer that offers rewards for users of its card. Examples of such cards include a Macy's or Nordstrom credit card, a Gap store card, or a Costco card. The payment card typically includes a magnetic stripe on the back on the card. The magnetic stripe contains information such as an account number, expiration date, security code, name, phone number, and other user/account identifiers. Card information may be stored in other ways, such as a computer chip within the card that enables the information to be read through an NFC reader, an RFID reader, or other suitable chip reader devices. As such, “swiping” as used herein may also refer more broadly to the card being read.

At step 202, the user 102 makes a purchase (either offline or online), and provides a payment card to the merchant. For example, the payment card may be swiped at a physical store, or the payment card details may be provided on a merchant website. The payment card details are passed from the merchant server 130 to the service provider server 180. Payment card details may include the payment card number, expiration date, account holder address, and account holder's name.

In various embodiments, the user 102 previously configured the payment card to act as their login credentials to their user account with the service provider. That is, instead of the user 102 entering identifying information (e.g., user name, password, PIN, phone number, address, etc.) to access their user account, the user 102 merely swipes the payment card, or provides payment card details on a merchant website.

In an example, the user 102 swipes a payment card at a merchant point of sale (POS) device. The POS device electronically transmits the user's payment card number (or other user/account identifier), along with a payment or purchase request, to the service provider server 180. The payment request may include details of the transaction, such as merchant identifier, a merchant account number with the service provider, a merchant account number with a bank, total purchase account, item descriptions, item costs, item identifiers, etc.

At step 204, the service provider server 180 receives the payment card details and uses the details to identify a user account associated with the payment card. The details can be taken and matched with a user account with the service provider. For example, the service provider takes the payment card number and finds a user account associated with the payment card number. In some embodiments, the service provider determines that the name on the user account matches the name on the payment card.

If the payment card cannot be associated with a user account, the payment card itself may be used to fund the transaction. In other embodiments, the user 102 may be prompted to provide another payment card, and the service provider may then determine if this payment card is associated with a user account with the service provider.

At step 206, the service provider server 180 accesses the user account and retrieves a funding source linked to the user account. Accessing the account allows the service provider to determine certain information about the user 102 and the user account, such as account limits or restrictions, and available funding sources.

The funding source can include the payment card, other credit/debit cards, or a bank account (e.g., checking or savings account). Advantageously, the user 102 is not limited to using the payment card to fund the transaction, but may use a different funding source linked to the user account with the service provider. Although the user 102 is only carrying or using one card, he or she is able to access other cards and financial accounts. For example, the payment card may be a Visa® credit card, but payment made by made through the service provider using a Discover® card.

In other words, a typical processing with the service provider is made possible through the use of the payment card. The service provider may be able to offer specific features available through the service provider, such as account management, incentives available through the user's account or obtained by the service provider, suggestions for best mix of funding sources, receipt handling, etc.

At step 208, the service provider server 180 processes the purchase using the funding source(s). Note that the user account with the service provider may have preferences or settings to use multiple funding sources for a transaction. The selection of which funding sources to use may depend on the amount of the transaction, the merchant, user preferences, date of the transaction, type of purchase, etc. The processing may include debiting the appropriate amount of funds from the specified funding source(s) and crediting the appropriate amount of funds to the merchant. The funding source(s) used may be the primary or default funding source set up by the user 102. In another embodiment, the funding source is selected based on what payment methods are accepted by the merchant. For example, the merchant may take a MasterCard® credit card, but not an American Express® credit card. If the user 102 swipes an American Express® credit card, the service provider can use a linked MasterCard® credit card to pay for the purchase. As such, both merchants and consumers can take advantage of additional funding sources provided by the service provider.

The present disclosure describes systems and methods that allow a user with a payment card to use their account with a service provider. Even though the payment card is not issued by the service provider, a payment transaction is processed by the service provider instead of the bank or credit card company who issued the payment card. The service provider funds the transaction using the user's account with the service provider. Thus, the user can pay for a purchase through the user's service provider account using an ordinary credit or debit card.

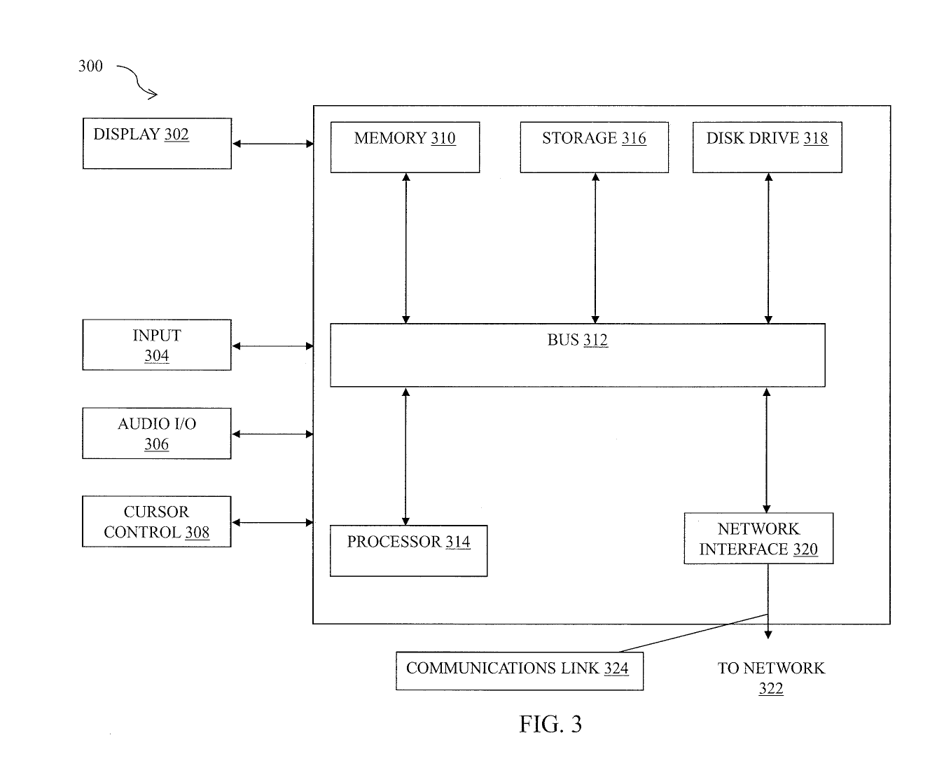

FIG. 3 is a block diagram of a computer system 300 suitable for implementing one or more embodiments of the present disclosure, including the user device 120, merchant server 130, and the service provider server 180. In various implementations, the user device 120 may comprise a mobile cellular phone, personal computer (PC), laptop, wearable computing device, etc. adapted for wireless communication, and the merchant server 130 and service provider server 180 may comprise a network computing device, such as a server. Thus, it should be appreciated that the devices 120, 130, and 180 may be implemented as computer system 300 in a manner as follows.

Computer system 300 includes a bus 312 or other communication mechanism for communicating information data, signals, and information between various components of computer system 300. Components include an input/output (I/O) component 304 that processes a user (i.e., sender, recipient, service provider) action, such as selecting keys from a keypad/keyboard, selecting one or more buttons or links, etc., and sends a corresponding signal to bus 312. I/O component 304 may also include an output component, such as a display 302 and a cursor control 308 (such as a keyboard, keypad, mouse, etc.). An optional audio input/output component 306 may also be included to allow a user to use voice for inputting information by converting audio signals. Audio I/O component 306 may allow the user to hear audio. A transceiver or network interface 320 transmits and receives signals between computer system 300 and other devices, such as another user device, a merchant server, or a service provider server via network 322. In one embodiment, the transmission is wireless, although other transmission mediums and methods may also be suitable. A processor 314, which can be a micro-controller, digital signal processor (DSP), or other processing component, processes these various signals, such as for display on computer system 300 or transmission to other devices via a communication link 324. Processor 314 may also control transmission of information, such as cookies or IP addresses, to other devices.

Components of computer system 300 also include a system memory component 310 (e.g., RAM), a static storage component 316 (e.g., ROM), and/or a disk drive 318. Computer system 300 performs specific operations by processor 314 and other components by executing one or more sequences of instructions contained in system memory component 310. Logic may be encoded in a computer readable medium, which may refer to any medium that participates in providing instructions to processor 314 for execution. Such a medium may take many forms, including but not limited to, non-volatile media, volatile media, and transmission media. In various implementations, non-volatile media includes optical or magnetic disks, volatile media includes dynamic memory, such as system memory component 310, and transmission media includes coaxial cables, copper wire, and fiber optics, including wires that comprise bus 312. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 324 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing user account information; and
one or more processors in communication with the memory device and operable to:
receive a payment request and payment card information from a payment card, wherein the payment card is not issued by a service provider;
identify a user account with the service provider based on the payment card information; and
process the payment request using at least one funding source linked to the user account.

2. The system of claim 1, wherein the at least one funding source is different than the payment card.

3. The system of claim 1, wherein the payment card is associated with a merchant.

4. The system of claim 1, wherein the one or more processors are further operable to retrieve the at least one funding source from the user account.

5. The system of claim 1, wherein the one or more processors are further operable to receive funding source information from a user.

6. The system of claim 1, wherein the at least one funding source is designated as a primary or default funding source.

7. The system of claim 1, wherein the one or more processors are further operable to select the at least one funding source based on accepted payment methods.

8. A method for facilitating payment, comprising:
receiving, by one or more hardware processors of a service provider, a payment request and payment card information from a payment card, wherein the payment card is not issued by a service provider;
identifying, by the one or more hardware processors, a user account with the service provider based on the payment card information; and
processing, by the one or more hardware processors, the payment request using at least one funding source linked to the user account.

9. The method of claim 8, wherein the payment card is issued by a bank or credit card company.

10. The method of claim 8, wherein the payment card is used to login to the user account.

11. The method of claim 8, wherein the at least one funding source is different than the payment card.

12. The method of claim 8, further comprising receiving funding source information from a user.

13. The method of claim 8, further comprising selecting the at least one funding source based on accepted payment methods.

14. The method of claim 8, wherein the payment is processed using multiple finding sources.

15. A non-transitory machine-readable medium comprising instructions which, in response to a computer system, cause the computer system to perform a method comprising:
receiving a payment request and payment card information from a payment card, wherein the payment card is not issued by a service provider;
identifying a user account with the service provider based on the payment card information; and
processing the payment request using at least one funding source linked to the user account.

16. The non-transitory machine-readable medium of claim 15, wherein the at least one funding source is different than the payment card.

17. The non-transitory machine-readable medium of claim 15, wherein identifying the user account comprises matching the payment card information to user account information.

18. The non-transitory machine-readable medium of claim 15, further comprising receiving funding source information from a user.

19. The non-transitory machine-readable medium of claim 15, wherein the method further comprises selecting the at least one funding source based on accepted payment methods.

20. The non-transitory machine-readable medium of claim 15, wherein the payment card is used to login to the user account.
